(19) United States
(12) Patent Application Publication
(10) Pub. No.: US 2008/0130552 A1
(43) Pub. Date: Jun. 5, 2008

(54) CONNECTION NODE, METHOD, AND COMPUTER READABLE MEDIUM THEREOF FOR RECALCULATING A TRANSMISSION OPPORTUNITY WHEN AN APPARATUS REQUESTS TO ENTER A WIRELESS NETWORK

(75) Inventors: Shie-Yuan Wang, Hsinchu (TW); Frank Chee-Da Tsai, Taipei (TW); Hsu-Heng Weng, Taipei (TW); Chih-Che Lin, Chung-He City (TW); Ku-Han Fan, Chung-He City (TW); Teng-Wei Hsu, Taichung (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 11/683,522

(22) Filed: Mar. 8, 2007

(30) Foreign Application Priority Data
Dec. 1, 2006 (TW) 095144831

(51) Int. Cl. H04Q 7/00

(52) U.S. Cl. 370/328

(57) ABSTRACT

A connection node, a method, a computer program, and a computer readable medium thereof for recalculating a transmission opportunity when an apparatus requests to enter a wireless network are provided. A receiving module receives a mesh network entry message transmitted from the apparatus. A memory stores an identification of a sponsor node. A processing module determines whether an original neighboring node list comprises the identification. If no, the processing module updates the original neighboring node list according to the identification, and recalculates a transmission opportunity of a mesh network configuration message of the connection node. Finally, a transmission module transmits the mesh network configuration message according to the transmission opportunity in order to solve the problem that mesh network configuration messages of nodes collide with each other of the prior art.

This application claims the benefit of priority based on Taiwan Patent Application No. 095144831 filed on Dec. 1, 2006 of which the contents are incorporated herein by reference in its entirety.

### CROSS-REFERENCES TO RELATED APPLICATIONS

Not applicable.

### BACKGROUND OF THE INVENTION

1. Field of the Invention

The present invention relates to a connection node, a method, and a computer readable medium thereof for recalculating a transmission opportunity when an apparatus enters a wireless network.

2. Descriptions of the Related Art

With the rapid development of the computer network, various broadband services are now essential to the information industry. However, only part of computer users in the whole world can use high speed wired broadband services, such as the digital subscribe line (DSL) and the cable broadband access. From network telecommunication service providers point of view, they desire to expand the coverage range of the broadband network. However, the related infrastructure costs for building the wired network make the providers move back. Broadband wireless techniques, hence, become an important solution. In light of communication distance, the current techniques of the wireless network can be classified into the wide area network (WAN), the metropolitan area network (MAN), the local area network (LAN), and the personal area network (PAN).

IEEE 802.16, worldwide interoperability for microwave access (WiMax), is a newly developing wireless transmission standard. The original establishing objective is to set up a radio standard of the metropolitan network to provide a wireless broadband connection technique of “the last mile” for the telecommunication industry. After continuously improved by the researchers of IEEE 802.16, more market requests can be supported now, such as various mobile and high speed broadband applications. Furthermore, comparing with IEEE 802.11, i.e., Wi-Fi and the third generation mobile communication (3G) technique, IEEE 802.16 has the advantages of larger network bandwidth, lower construction cost, better service quality, better expansibility, and extending the usage mode of a Wi-Fi hot spot.

IEEE 802.16 defines two operation modes. One is the point to multipoint (PMP) mode which is used in the aforementioned wireless broadband connection technique of “the last mile” to replace the conventional fixed network, such as the asymmetric digital subscriber line (ADSL) or the T1 subscriber line. The other operation mode is the mesh mode which provides a high speed and reliable backbone network. After several years' research for the PMP mode, the current techniques are very mature and already applied widely. Although the mesh mode has many advantages, it involves a more complicated technique and does not mature yet. Hence, the mesh mode still requires a lot of development.

FIG. 1 depicts a common wireless network 1 which uses the mesh operation mode of the IEEE 802.16. The wireless network 1 comprises a base station 101, a plurality of connection nodes 103, 105, . . . , 111 and an apparatus 113 which is about to enter the wireless network 1. The apparatus 113 has an effective connection range 100. The connection node 107 has an effective connection range 102. The connection node 111 has an effective connection range 104. When the apparatus 113 intends to enter the wireless network 1, a network entry process is required to be executed so that the entering may be finished smoothly. The connection nodes 103, 105, . . . , 111 and the apparatus 113 can be anyone of a gateway, a router, and a terminal apparatus that transmits data under the mesh operation mode of the IEEE 802.16.

While the network entry process is executed, the apparatus 113 needs to search for a connection node as its sponsor node within the effective connection range 100 to assist the apparatus 113 and the base station 101 in performing the required process for data transmissions, such as authorization and registration. Assuming that the apparatus 113 selects the connection node 107 as its sponsor node, a mesh network entry message (MSH-NENT) 106 will be transmitted to the connection node 107. The connection node 107 will respond a mesh network configuration message (MSH-NCFG) 108 to the apparatus 113 for the following data transmission process.

Since the effective connection range 100 of the apparatus 113 covers the connection nodes 107 and 111, the apparatus 113 not only receives the mesh network configuration message 108 from the connection node 107, but also receives a mesh network configuration message 110 from the connection node 111. Although the effective connection range 102 and the effective connection range 104 both cover the apparatus 113, the effective connection range 104 does not cover the connection node 107.

When the connection node 111 intends to transmit the mesh network configuration message 110, a transmission opportunity for the mesh network configuration message 110 is calculated first according to the current specification of the IEEE 802.16 standard, wherein the transmission opportunity is used for the connection node 111 to control the timing for transmitting the mesh network configuration message 110. The transmission opportunity is calculated according to a neighboring node list stored in the connection node 111. More particularly, the calculation of the transmission opportunity takes the connection nodes 103 and 109 covered by the effective connection range 104 into account to avoid a collision between the mesh network configuration message 110 and a mesh network configuration message transmitted from the connection nodes 103 or 109. It is noted that although the apparatus 113 is within the effective connection range 104, it does not join the wireless network 1 yet. Thus, it is not considered when the transmission opportunity of the mesh network configuration message 110 is calculated. Since the effective connection range 104 does not cover the connection node 107, the neighboring node list of the connection node 111 does not record any data about the connection node 107. Therefore, when the connection node 111 calculates the transmission opportunity of the mesh network configuration message 110, the influence from the connection node 107, the sponsor node of the apparatus 113, is not considered. Therefore, when the connection node 107 responds the mesh network configuration message 108 to the apparatus 113, it is highly possible to collide with the mesh network configuration message 110. Under the circumstance, the apparatus 113 cannot read the mesh network configuration message 108 correctly so that the apparatus 113 fails to continue the following data transmission process for entering the wireless network 1.

According to the aforementioned descriptions, due to the collision between the mesh network configuration message 108 and the mesh network configuration message 110, the success ratio for the apparatus 113 to join the wireless network 1 is reduced significantly. Therefore, how to make the node 111 consider the influence of the sponsor node of the apparatus 113 when the node 111 calculates its own transmission opportunity without changing the IEEE 802.16 specification is still an urgent topic for the industry to endeavor.

### SUMMARY OF THE INVENTION

One objective of this invention is to provide a method for a connection node to re-calculate a transmission opportunity when an apparatus requests to join a wireless network. The method comprises the following steps of: receiving a mesh network entry message transmitted from the apparatus; storing an identification of a sponsor node of the wireless network according to the mesh network entry message; determining whether an original neighboring node list comprises the identification; if not, adding the identification into the original neighboring node list to update the original neighboring node list; if the original neighboring node list does not comprises the identification, calculating a first transmission opportunity of a mesh network configuration message of the connection node according to the updated neighboring node list; and transmitting the mesh network configuration message of the connection node according to the first transmission opportunity.

A further objective of this invention is to provide a computer readable medium for storing a computer program. The computer program makes a connection node execute a method of re-calculating a transmission opportunity when an apparatus requests to join a wireless network. The method comprises the following steps of: making a receiving module receive a mesh network entry message from the apparatus; making a memory store an identification of a sponsor node of the wireless network according to the mesh network entry message; making a process module determine whether an original neighboring node list comprises the identification; if no, making the process module add the identification into the original neighboring node list to update the original neighboring node list; making the process module calculate a first transmission opportunity of a mesh network configuration message of the connection node according to the updated neighboring node list; and making a transmission module transmit the mesh network configuration message of the connection node according to the first transmission opportunity.

Yet a further objective of this invention is to provide a connection node capable of re-calculating a transmission opportunity when an apparatus requests to join a wireless network. The connection node comprises a receiving module, a memory, a processing module, and a transmission module. The receiving module is used for receiving a mesh network entry message from the apparatus. The memory is used for storing an identification of a sponsor node of the wireless network according to the mesh network entry message. The processing module is used for determining whether an original neighboring node list comprises the identification. If the original neighboring node list does not comprise the identification, the processing module adds the identification into the original neighboring node list to update the original neighboring node list, and calculates a first transmission opportunity of a mesh network configuration message of the connection node according to the updated neighboring node list. The transmission module transmits the mesh network configuration message of the connection node according to the first transmission opportunity.

This invention is capable of adjusting the neighboring node list of a connection node according to the identification of the sponsor node so that the calculation of the transmission opportunity of the connection node may consider the influence of the sponsor node with reference to the neighboring node list. Without changing the IEEE 802.16 specification, the invention solves the problem that, when an apparatus is about to join a wireless network, a collision will occurs if other connection nodes simply calculates the transmission opportunity based on the neighboring node list without comprising the identification of the sponsor node. This invention increases the whole efficiency and usability of the IEEE 802.16 mesh network with high density distribution of nodes. When the nodes of the IEEE 802.16 mesh network are deployed in a large number in the future, a new node can enter the mesh network quickly

The detailed technology and preferred embodiments implemented for the subject invention are described in the following paragraphs accompanying the appended drawings for people skilled in the art to well appreciate the features of the claimed invention.

### BRIEF DESCRIPTION OF THE DRAWINGS

FIG. 1 is a schematic diagram of a conventional wireless network under an IEEE 802.16 mesh operation mode;

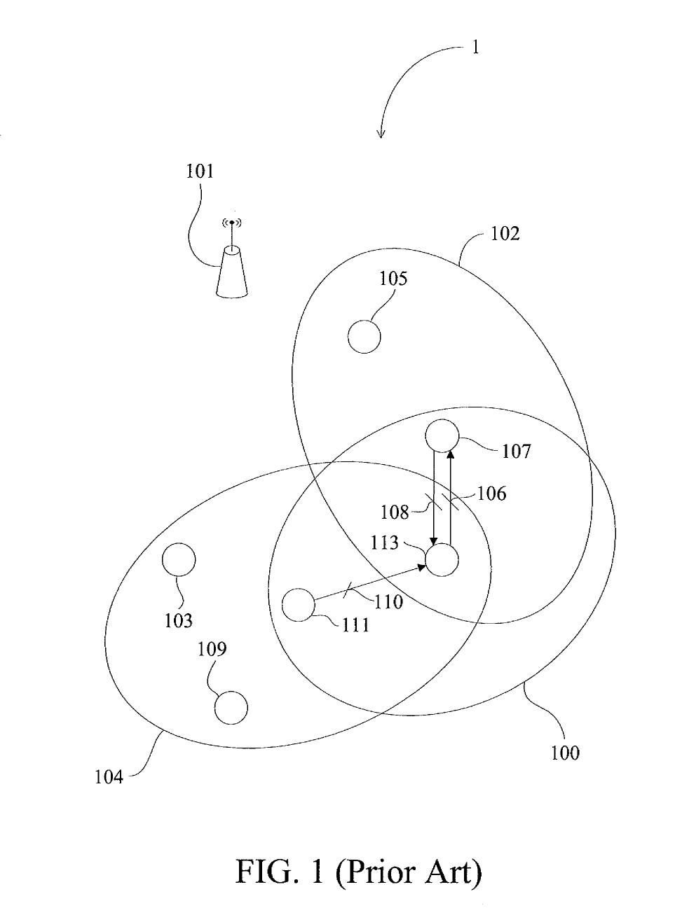

FIG. 2 is a schematic diagram of a wireless network of a first embodiment of this invention;

FIG. 3 is a schematic diagram of a connection node of the first embodiment; and

FIG. 4 is a flow chart of a second embodiment and a third embodiment of this invention.

### DESCRIPTION OF THE PREFERRED EMBODIMENT

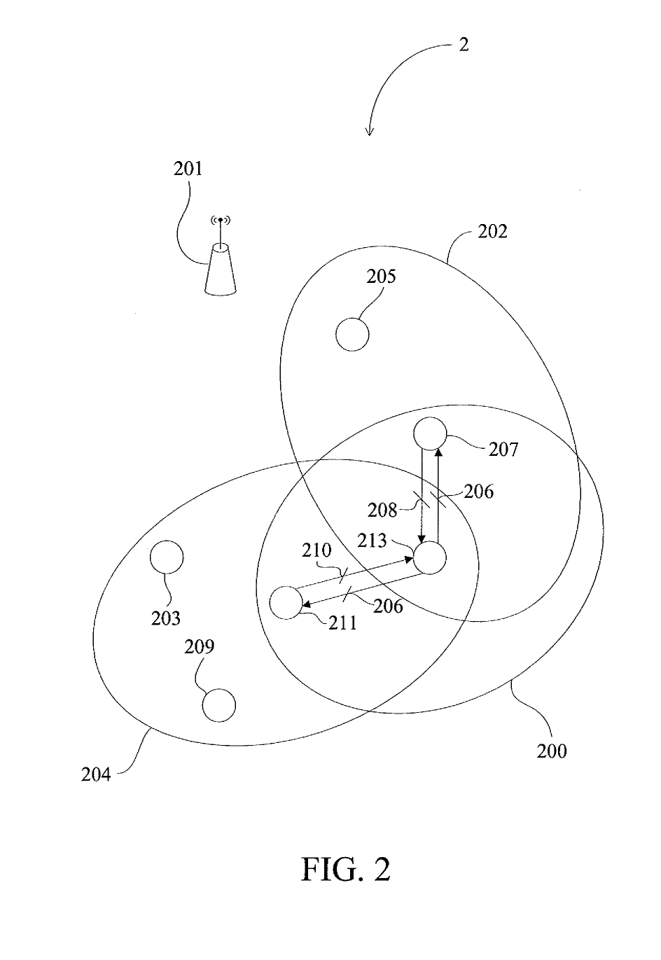

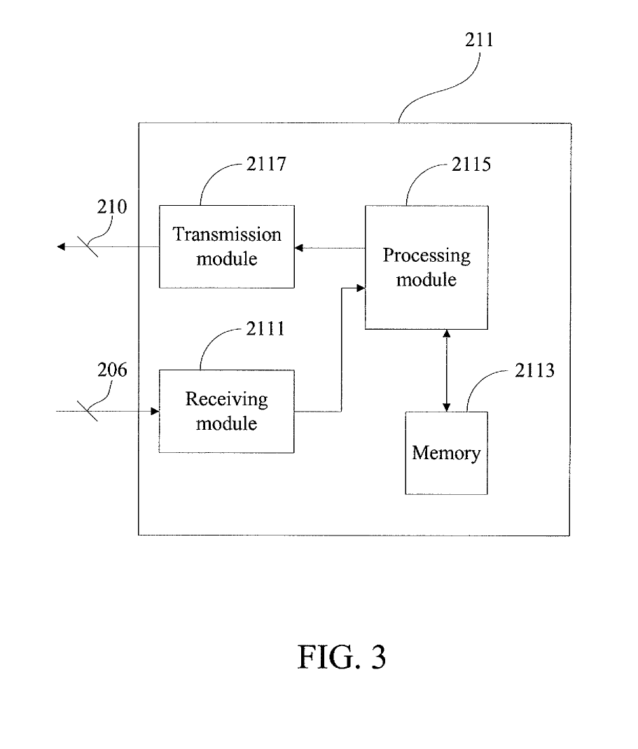

A first embodiment of this invention is shown in FIG. 2 which is a wireless network 2 under IEEE 802.16 mesh mode operation. The wireless network 2 comprises a base station 201, a plurality of nodes 203, 205, 207, 209, 211 and an apparatus 213 which is about to join the wireless network 2, wherein the node 211 is a connection node located within an effective connection range 200 of the apparatus 213 in this embodiment. In response to the joining of the apparatus 213, the connection node 211 has to re-calculate its own transmission opportunity. The connection node 211, as shown in FIG. 3, comprises a receiving module 2111, a memory 2113, a processing module 2115, and a transmission module 2117. The nodes 203, 205, 207, 209, the connection node 211, and the apparatus 213 can be anyone of a gateway, a router, and a terminal apparatus operate under the IEEE 802.16 mesh mode.

The apparatus 213 has an effective connection range 200. The node 207 has an effective connection range 202. The connection node 211 has an effective connection range 204. When the apparatus 213 intends to join the wireless network 2, it must search for a connection node as its sponsor node which is covered by the effective connection range 200. In this embodiment, assume that the node 207 is the sponsor node of the apparatus 213. After the apparatus 213 assigns the sponsor node 207, a mesh network entry message 206 is transmitted to the sponsor node 207. Then the apparatus 213 waits for a mesh network configuration message 208 from the sponsor node 207 to perform the following data transmission process. When the apparatus 213 transmits the mesh network entry message 206, the receiving module 2111 of the connection node 211 also receives the mesh network entry message 206 since the connection node 211 is also within the effective connection range 200. The processing module 2115 stores an identification of the sponsor node 207 carried by the mesh network entry message 206 into the memory 2113. After that, the processing module 2115 determines whether an original neighboring node list stored in the memory 2113 comprises the identification of the sponsor node 207. If no, the processing module 2115 adds the identification of the sponsor node 207 into the original neighboring node list to update the original neighboring node list and calculates the transmission opportunity of the mesh network configuration message 210 according to the updated neighboring node list. That is, the nodes 203, 209, and the sponsor node 207 are considered while calculating a suitable timing for transmitting the mesh network configuration message 210. Finally, the transmission module 2117 transmits the mesh network configuration message 210 according to the updated transmission opportunity.

Under another condition, if the effective connection range 204 covers the sponsor node 207, the processing module 2115 will determine that the original neighboring node list already comprises the identification of the sponsor node 207. Therefore, while the transmission opportunity of the mesh network configuration message 210 is calculated, the influence of the sponsor node 207 has been considered. The processing module 2115 calculates the transmission opportunity directly according to the original neighboring node list, and the transmission module 2117 transmits the mesh network configuration message 210 according to the transmission opportunity.

According to the aforementioned descriptions, even if the effective connection range 204 does not cover the sponsor node 207, the processing module 2115 can still obtain the identification of the sponsor node 207 from the mesh network entry message 206 to update the original neighboring node list of the connection node 211. Therefore, the influence of the sponsor node 207 can be considered while calculating the transmission opportunity of the mesh network configuration message 210. The possibility of collision between the transmissions of the mesh network configuration message 208 and the mesh network configuration message 210 is avoided. In other words, a success ratio for the apparatus 213 joining the wireless network 2 is improved.

The invention does not limit how the connection node 211 obtains the identification of the sponsor node 207. The first embodiment of this invention adopts the network entry message 206 to obtain the identification of the sponsor node 207. However, this is only an example. Furthermore, when the apparatus 213 is about to join the wireless network 2, the connection node 211 can obtain the identification of the sponsor node 207 indirectly from the base station 201. Those skilled in the art can easily realize other ways to obtain the identification of the sponsor node 207.

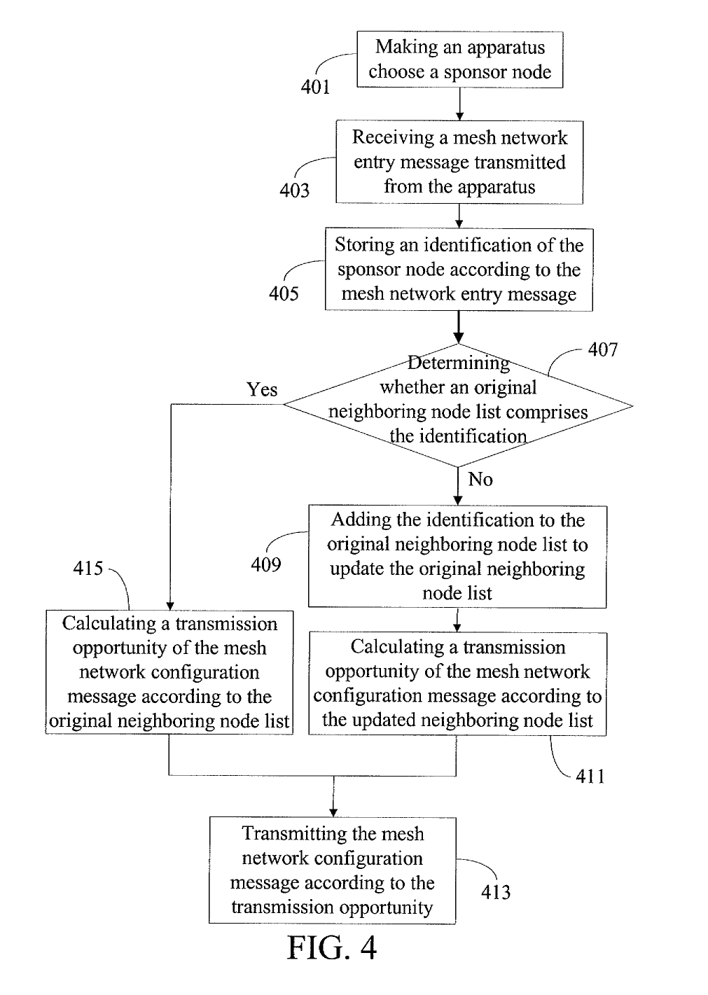

A second embodiment of this invention is to provide a method for re-calculating a transmission opportunity when an apparatus is about to join a wireless network, the method is applied to the connection node 211 as described in the first embodiment. More practically, the method of the second embodiment is applied by a computer program to control each module of the connection node 211. The corresponding flow chart is shown in FIG. 4.

At first, step 401 is executed for making the apparatus choose a sponsor node. That is, the apparatus 213 chooses a sponsor node first. Next, step 403 is executed that the computer program makes the receiving module 2111 receive a mesh network entry message from the apparatus. Then step 405 is executed that the computer program makes the memory 2113 store an identification of the sponsor node according to the mesh network entry message by a processing module 2115. Step 407 is executed that the computer program makes the processing module 2115 determine whether an original neighboring node list stored in the memory 2113 comprises the identification. If no, step 409 is executed that the computer program makes the processing module 2115 add the identification into the original neighboring node list to update the original neighboring node list. Next, step 411 is executed that the computer program makes the processing module 2115 calculate a transmission opportunity according to the updated neighboring node list. Final, step 413 is executed that the computer program makes the transmission module 2117 transmit the mesh network configuration message according to the transmission opportunity.

In step 407, if the original neighboring node list comprises the identification, step 415 is executed that the computer program makes the processing module 2115 calculate a transmission opportunity according to the original neighboring node list. Refer back to step 413, it is executed that the computer program makes the transmission module 2117 transmit the mesh network configuration message according to the transmission opportunity.

Except the steps revealed in FIG. 4, the second embodiment can also execute all the operations of the first embodiment, those skilled in the art can understand the corresponding steps and operations of the second embodiment by the explanation of the first embodiment, and thus no unnecessary detail is given.

A third embodiment of this invention is to provide another method for a connection node to re-calculate a transmission opportunity when an apparatus is about to join a wireless network. A flow chart of this method is shown in FIG. 4.

At first, step 401 is executed for choosing a sponsor node. Step 403 is executed for receiving a mesh network entry message from the apparatus. Step 405 is executed for storing an identification of the sponsor node according to the mesh network entry message. Step 407 is executed for determining whether an original neighboring node list comprises the identification. If no, step 409 is executed for making the identification be added into the original neighboring node list to update the original neighboring node list. Next, step 411 is executed for calculating a transmission opportunity of a mesh network configuration message according to the updated neighboring node list. Finally, step 413 is executed for transmitting the mesh network configuration message according to the transmission opportunity.

In step 407, if the original neighboring node list comprises the identification, step 415 is executed for calculating the transmission opportunity of the mesh network configuration message according to the original neighboring node list. Refer back to step 413, it is executed for transmitting the mesh network configuration message according to the transmission opportunity

Except the steps revealed in FIG. 4, the third embodiment can also execute all the operations of the first embodiment, those skilled in the art can understand the corresponding steps or operations of the third embodiment by the explanation of the first embodiment, and thus no unnecessary detail is given.

According to the aforementioned descriptions, this invention updates the neighboring node list of the connection nodes which comprises the identification of the sponsor node according to the mesh network entry message, and recalculates the transmission opportunity of the mesh network configuration message transmitted by the connection nodes. Under the premise of not changing the IEEE 802.16 specification, a collision condition among the mesh network configuration messages is successfully avoided.

The above disclosure is related to the detailed technical contents and inventive features thereof. People skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for a connection node to re-calculate a transmission opportunity when an apparatus requests to join a wireless network, comprising the steps of:
receiving a mesh network entry message (MSH-NENT) transmitted from the apparatus;
storing an identification of a sponsor node of the wireless network according to the mesh network entry message;
determining whether an original neighboring node list comprises the identification;
adding the identification into the original neighboring node list to update the original neighboring node list if the original neighboring node list does not comprise the identification;
calculating a first transmission opportunity of a mesh network configuration message (MSH-NCFG) of the connection node according to the updated neighboring node list; and
transmitting the mesh network configuration message of the connection node according to the first transmission opportunity.

2. The method of claim 1, further comprising the steps of:
calculating a second transmission opportunity of the mesh network configuration message of the connection node according to the original neighboring node list if the original neighboring node list comprises the identification; and
transmitting the mesh network configuration message of the connection node according to the second transmission opportunity.

3. The method of claim 1, the wireless network comprising a plurality of nodes, the method further comprising the steps of:
assigning one of the nodes as the sponsor node;
wherein an effective connection range of the apparatus covers the sponsor node and the connection node.

4. A computer readable medium storing a computer program for a connection node to execute a method for re-calculate a transmission opportunity when an apparatus requests to join a wireless network, the method comprising the steps of:
receiving a mesh network entry message transmitted from the apparatus;
storing an identification of a sponsor node of the wireless network according to the mesh network entry message;
determining whether an original neighboring node list comprises the identification;
adding the identification into the original neighboring node list to update the original neighboring node list if the original neighboring node list does not comprise the identification;
calculating a first transmission opportunity of a mesh network configuration message of the connection node according to the updated neighboring node list; and
transmitting the mesh network configuration message of the connection node according to the first transmission opportunity.

5. The computer readable medium of claim 4, the method further comprising the steps of:
calculating a second transmission opportunity of the mesh network configuration message of the connection node according to the original neighboring node list if the original neighboring node list comprises the identification; and
transmitting the mesh network configuration message of the connection node according to the second transmission opportunity.

6. The computer readable medium of claim 4, the wireless network comprising a plurality of nodes, the method further comprising the steps of:
assigning one of the nodes as the sponsor node;
wherein an effective connection range of the apparatus covers the sponsor node and the connection node.

7. A connection node capable of re-calculating a transmission opportunity when an apparatus requests to join a wireless network, comprising:
a receiving module for receiving a mesh network entry message transmitted from the apparatus;
a memory for storing an identification of a sponsor node of the wireless network according to the mesh network entry message;
a processing module for determining whether an original neighboring node list of the connection node comprises the identification; and
a transmission module;
wherein if the original neighboring node list does not comprise the identification, the processing module adds the identification into the original neighboring node list to update the original neighboring node list, and calculates a first transmission opportunity of a mesh network configuration message of the connection node according to the updated neighboring node list, and the transmission module transmits the mesh network configuration message of the connection node according to the first transmission opportunity.

8. The connection node of claim 7, wherein if the original neighboring node list comprises the identification, the processing module calculates a second transmission opportunity of the mesh network configuration message of the connection node according to the original neighboring node list, and the transmission module transmits the mesh network configuration message of the connection node according to the second transmission opportunity.

9. The connection node of claim 7, wherein the wireless network comprises a plurality of nodes, the apparatus assigns one of the nodes as the sponsor node, and an effective connection range of the apparatus covers the sponsor node and the connection node.
